(19) United States
(12) Patent Application Publication
(10) Pub. No.: US 2007/0028243 A1
(43) Pub. Date: Feb. 1, 2007

(54) A METHOD OR APPARATUS FOR DETERMINING THE MEMORY USAGE OF A PROGRAM

(76) Inventors: ROBERT F. BERRY, Durley (GB); MATTHEW F. PETERS, Winchester (GB)

Correspondence Address: IBM CORPORATION;INTELLECTUAL PROPERTY LAW, 11400 BURNET ROAD, AUSTIN, TX, 78758, US

(21) Appl. No.: 11/456,362

(22) Filed: Jul. 10, 2006

(30) Foreign Application Priority Data
Jul. 27, 2005 (GB) 0515395.2

(51) Int. Cl. G06F 9/46

(52) U.S. Cl. 718/104

(57) ABSTRACT

A method and apparatus for determining the memory usage of a program is disclosed in which a first and second programs are run, the memory-allocation of the second program is increased and the performance of the first or second programs is monitored against predetermined performance criteria. When the performance of the first or second program fails to meet the predetermined performance criteria the memory usage of the first program is recorded.

### FIELD OF INVENTION

The present invention relates to a method or apparatus for determining the memory usage of a program.

### BACKGROUND OF THE INVENTION

When managing a computer system it is desirable to determine the current memory requirements of the system. One factor that effects the memory requirements is the memory used by programs as they run. There are a number of ways of measuring the memory usage of a program. If a program runs with insufficient memory, its performance will be reduced as it is forced to page memory, that is, access data from storage such as disk rather than memory. Some operating systems are arranged to free up memory by removing less used pages of memory into storage.

One method determines the working set for a program, that it, the pages of memory that a program will use in the near future. However, determining the real working set of an application is difficult. Some operating systems do not record information on which pages of memory have been accessed recently. Other systems treat the working set as the pages that are resident in memory at a given time. These pages are not necessarily the pages being used by the program. For example, the operating system may not have paged out rarely accessed pages.

Some systems attempt to determine the working set for a program by forcing the operating system to remove or page out the less frequently used pages from memory until only the frequently used pages or working set remains. These systems operate by blocking off portions of memory before running the application being tested. The performance of the program is then monitored to determine whether or not the reduced memory forces the program to page in memory from storage. If not then the program is stopped, a further portion of memory is blocked and the program restarted and monitored with the reduced memory availability. When the performance of the program is reduced due to increased paging in of memory, this indicates that the minimum memory or working set has been reached.

One problem with such system is that repeatedly starting and stopping large and/or complex programs is time consuming. Furthermore, some programs use significantly more memory during their start up and initial processing before settling into a state where less memory is used. If the remaining the program then start up may fail or consume even more time. Some programs may not run at all if insufficient memory is available.

### SUMMARY OF THE INVENTION

An embodiment provides a method for determining the memory usage of a computer program, the method comprising the steps of

a) running a first program;

b) running a second program;

c) increasing the memory allocation of the second program;

d) monitoring the performance of the first and second programs against predetermined performance criteria; and

e) recording the memory usage of the second program when the performance of the first or second program fails to meet the predetermined performance criteria.

In step a) the first program may be driven to perform to a predetermined threshold, the second program may be operable to reserve a total amount of memory for use while running and may commit a proportion of the total amount of memory on start-up. The second program may increase the committed memory by predetermined increments concurrently with the running of the first program. The second program may maintain the committed memory by periodically accessing the committed memory. The performance criteria may be different for the first and second programs. The performance criteria for the first program may be a predetermined rate of data processing steps. The performance criteria for the second program may be a time threshold for periodically accessing the committed memory.

The method may comprise the further step of running two instances of the first program and recording the memory usage of the second program when the performance of either of the first programs or the second program fails to meet the predetermined performance criteria. The method may be carried out a first time with one instance of the first program and a second time with two instances of the first program and the memory usage for the first program determined from the difference between the memory usage recorded for the first and second times. The memory usage may be the real working set for the first program. The first program may be an application program. The first or second programs may comprise a group of one or more programs.

Another embodiment provides apparatus for determining the memory usage of a computer program, the apparatus being operable to: run a first program; run a second program; increase the memory allocation of the second program;

monitor the performance of the first or second programs against predetermined performance criteria; and

record the memory usage of the second program when the performance of the first or second program fails to meet the predetermined performance criteria.

Some embodiments provide apparatus for determining the memory usage of a program, the apparatus comprising:

means for running a first program;

means for running a second program;

means for increasing the memory allocation of the second program;

means for monitoring the performance of the first or second programs against predetermined performance criteria; and

means for recording the memory usage of the first program when the performance of the first or second program fails to meet the predetermined performance criteria.

Other embodiments provides a program or group of programs arranged to enable a programmable device or group of such devices to carry out the method for determining the memory usage of a computer program, the method comprising the steps of:

a) running a first program;

b) running a second program;

c) increasing the memory allocation of the second program;

d) monitoring the performance of the first and second programs against predetermined performance criteria; and

e) recording the memory usage of the second program when the performance of the first or second program fails to meet the predetermined performance criteria.

Some embodiments provides a program or group of programs arranged to enable a programmable device or group of such devices to provide apparatus for determining the memory usage of a computer program, the apparatus being operable to:

run a first program;

run a second program;

increase the memory allocation of the second program;

monitor the performance of the first or second programs against predetermined performance criteria; and

record the memory usage of the second program when the performance of the first or second program fails to meet the predetermined performance criteria.

Other embodiments provides a program or group of programs arranged to enable a programmable device or group of such devices to provide apparatus for determining the memory usage of a program, the apparatus comprising:

means for running a first program;

means for running a second program;

means for increasing the memory allocation of the second program;

means for monitoring the performance of the first or second programs against predetermined performance criteria; and

means for recording the memory usage of the first program when the performance of the first or second program fails to meet the predetermined performance criteria.

### BRIEF DESCRIPTION OF THE DRAWINGS

Embodiments will now be described, by way of example only, with reference to the accompanying drawings in which:

FIG. 1 is a schematic illustration of a computer system with an operating system running two programs;

FIG. 2 is a schematic illustration of the structure of one of the programs of FIG. 1;

FIG. 3 is a time sequenced illustration of memory usage by the programs of FIG. 1;

FIG. 4 is a graph illustrating the performance of the programs of FIG. 1; and

FIG. 5 is a flow chart illustrating the processing carried out by the program of FIG. 2.

### DETAILED DESCRIPTION OF EMBODIMENTS

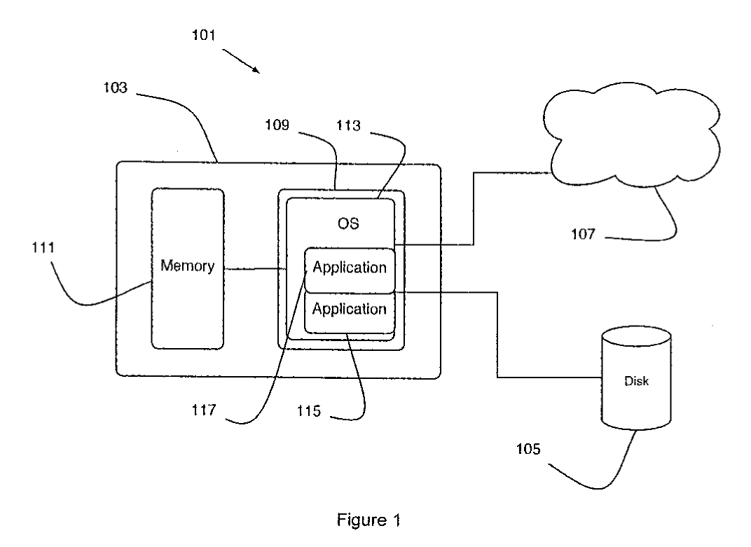

With reference to FIG. 1, a computer system 101 comprises a computer 103 to a storage device 105 in the form of a disk drive and wide area network 107 in the form of the internet. The computer 103 comprises a processor 109 connected to a memory 111 in the form of random access memory (RAM). An operating system 113 is installed on the computer 103 which is a version of the Linux™ operating system. The computer also has two programs installed in the form of a first program 115 and a second program 117.

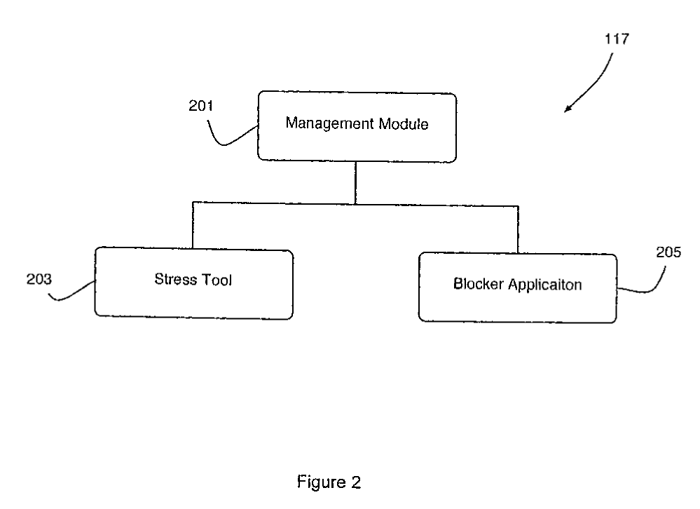

The first program 115 is a web server application program (WS) which operates over the network 107 to provide data and services to other computers (not shown). The second program 117 is a test program arranged to determine the memory usage in the form of the working set of the first program 115. With reference to FIG. 2, the test program 117 comprises three main parts, a management module 201, a stress tool 203 and a blocker application 205. The test program operates by running the first program 115 and the blocker application 205 concurrently. The stress tool is arranged to drive the first program 115 to a predetermine level such as a level that represents normal usage. The blocker application is arranged to incrementally increase its memory usage over time. The management module monitors the performance of the first and second programs 115, 117 against predetermined performance criteria.

As the memory 111 becomes full due to the operation of the blocker application 205, the operating system comes under pressure to free up space in the memory 111 by removing underused pages from the memory into the storage 105 in a process called paging out. At some point, either the blocker application 205 or the WS 115 are forced to access one or more regularly used memory pages from storage 105 rather than memory 111 in a process referred to as paging in. Paging in markedly reduces the performance of either program.

The management module is arranged to detect this drop in performance of either program which marks the point at which the combined working set for the WS has been reached. At this point, the management module 201 records the amount (B1) of memory blocked by the blocker application. The process is then repeated with two instances of the WS running until a drop in performance is detected at which point the amount (B2) of memory blocked by the blocker application is recorded. The memory usage or working set of the WS can then be calculated as B1 minus B2. Running the process twice, one with two instances of the WS enables the unknown memory allocation of the operating system and any other programs to be accounted for.

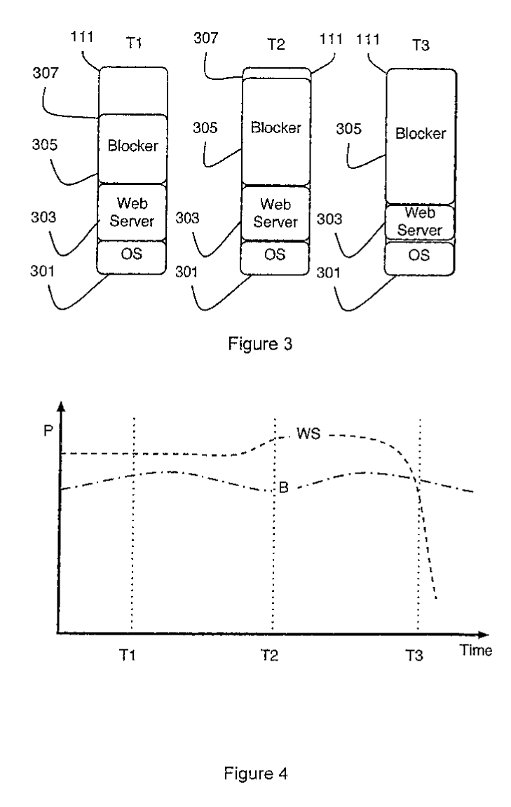

FIG. 3 represents the state of the memory 111 at a set of points in time T1, T2, T3 during the running of the test program 117. At time T1, the test program has recently started up with a small allocation 301 of the memory 111 to the OS, a larger allocation 3 03 to the WS and a still larger allocation 305 to the blocker. A large section 307 of memory 111 remains free at time T1. At time T2, the blocker application has increased its allocation 305 but a small section 3 07 of memory still remains free. At time T3, the blocker application has increased its allocation 305 so that there is no free memory. The allocation 303 for the WS has been reduced by the OS paging out to storage in an attempt to create further free memory.

FIG. 4 is a graph illustrating the change in the performance criteria of the blocker application (B) and the WS during the processing described above with reference to FIG. 3. While free memory exists at times T1 and T2, the performance of each program remains steady. However, at time T3, when there is no longer any free memory and the WS beings to page in memory and its performance markedly reduces. This reduction in performance is detected by the management module 201 and memory allocation 305 of the blocker application is recorded as B1. As noted above, the process is then repeated running two instances of the WS to determine B2 to enable the calculation of the working set for the WS.

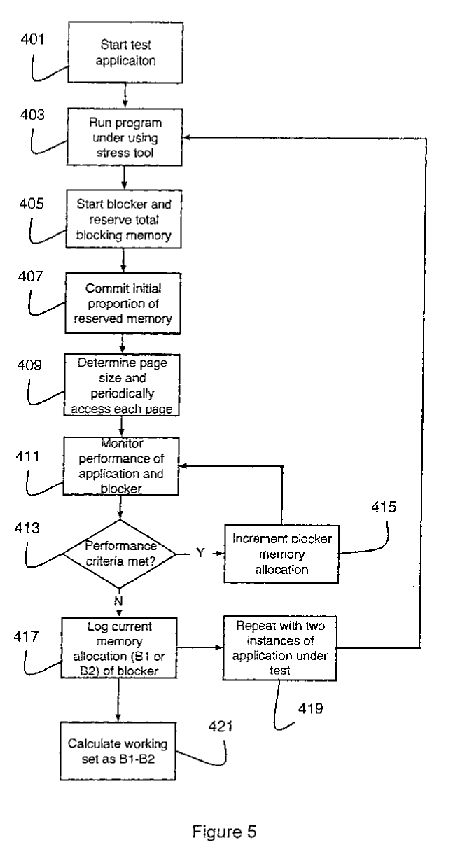

The processing carried out by the test program 117 will now be described further with reference to the flow chart of FIG. 5. A step 401 the test program 117 is started and processing moves to step 403. At step 403, the program under test is started up and driven by the stress tool 203. Processing then moves to step 405 where the blocker application is started and proceeds to reserve any remaining free memory with the OS thus barring access to that memory for any other processes. Processing then moves to step 407 where the blocker commits a first portion of the reserved memory and processing then moves to step 419.

At step 419, the blocker determines memory page size from the OS and proceeds to minimally access each page that it has committed in order to ensure that the pages remain in memory. The minimal access is in the form of reading or writing a single character to each page. The average time taken to access all the committed pages determines the performance criteria for the blocker application. If the pages are all in memory they can be accessed very quickly. For example, it may take only one hundredth of a second to minimally access 100 megabytes (MB) of 4 kilobyte (K) pages. If any of the pages are not in main memory and need to be paged in then this time will grow sharply, with each page that needs to be paged in adding one hundredth of a second to the total. Thus, when only a few pages are paged in there is a sharp increase in the average time to access all the pages that the blocker application has committed. For the example above of 100 MB of 4K pages, the average time would increase from a small fraction of a second to more than one second. The performance criteria for the WS 115 is set to the expected number of transactions it processes under nominal conditions provided by the stress tool.

From step 419, processing moves to step 411 where the management module 201 monitors the performance of the WS and the blocker application. If the performance criteria are being met then processing moves to step 415 where the blocker application increments its memory allocation by committing a further portion of its allocated memory and processing returns to step 411. These steps 413, 415 are repeated effectively in parallel until either the blocker application or the WS fails to meet its performance criteria at which point processing moves to step 417.

At step 417, the current memory committed by the blocker application is recorded as B1. Processing then moves to step 419 where the processes of step 401 to 417 are repeated as described above but with two instances of the WS running to calculate B2. Processing then moves to step 421 where the memory usage or working set of the WS is calculated as B1 minus B2 and processing ends.

In another embodiment, the blocker application is arranged to record its memory usage and report this to the management module when requested. In a further embodiment, the memory usage is reported to the management module by the blocker application each time it is incremented.

In some embodiments the memory usage (M) of other processes than the WS and the blocker are known. Such other processes include the OS and a range of application programs. In this case, the test process described above with reference to FIG. 5 need only be run once with a single instance of the application under test to calculate B1. The working set of the application under test can then be calculated as the difference between the total memory and the sum of B1 and M. In this arrangement, the combined working set of the application and the other programs can also be calculated as the difference between the total memory and B1. In some embodiments, instead of the memory allocation of the blocker application being recorded as B1, the memory allocation of the application under test is recorded thus directly deriving the size of the working set.

In another embodiment, the management module is arranged, at the point where it detects the change in the performance characteristics, to control the blocker application to home in on the point which the change occurs. For example at T3 in FIG. 4, the blocker application is arranged to unblock a smaller increment of the memory it has blocked and continues to do this until the performance improves at which point an even smaller increment of memory is re-blocked. Effectively, the blocker carries out a binary search of a predetermined number of steps so as to gain a more accurate determination of B1 or B2.

It will be understood by those skilled in the art that the apparatus that embodies a part or all of the present invention may be a general purpose device having software arranged to provide a part or all of an embodiment of the invention. The device could be single device or a group of devices and the software could be a single program or a set of programs. Furthermore, any or all of the software used to implement the invention can be communicated via suitable transmission or storage so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method for determining the memory usage of a computer program, the method comprising the steps of:
a) running a first program;
b) running a second program;
c) increasing the memory allocation of said second program;
d) monitoring the performance of the first and second programs against predetermined performance criteria; and
e) recording the memory usage of said second program when said performance of the first or second program fails to meet said predetermined performance criteria.

2. A method according to claim 1 in which in step a) said first program is driven to perform to a predetermined threshold.

3. A method according to claim 1 in which said second program is operable to reserve a total amount of memory for use while running and to commit a proportion of said total amount of memory on start-up.

4. A method according to claim 3 in which said second program increases said committed memory by predetermined increments concurrently with the running of said first program.

5. A method according to claim 3 in which said second program maintains said committed memory by periodically accessing said committed memory.

6. A method according to claim 1 in which said performance criteria are different for the first and second programs.

7. A method according to claim 1 in which said performance criteria for said first program is a predetermined rate of data processing steps.

8. A method according to claim 1 in which said performance criteria for said second program is a time threshold for periodically accessing said committed memory.

9. A method according to claim 1 comprising the further step of running two instances of said first program are run and recording the memory usage of said second program when the performance of either of said first programs or said second program fails to meet said predetermined performance criteria.

10. A method according to claim 9 in which said method is carried out a first time with one instance of said first program and a second time with two instances of said first program and said memory usage for said first program is determined from the difference between the memory usage recorded for said first and second times.

11. A method according to claim 10 in which said memory usage is the real working set for said first program.

12. A method according to claim 1 in which said first program is an application program.

13. A method according to claim 1 in which said first or second programs comprise a group of one or more programs.

14. Apparatus for determining the memory usage of a computer program, the apparatus comprising:
means for running a first program;
means for running a second program;
means for increasing the memory allocation of said second program;
means for monitoring the performance of the first or second programs against predetermined performance criteria; and
means for recording the memory usage of said second program when said performance of the first or second program fails to meet said predetermined performance criteria.

15. Apparatus according to claim 14 in which said first program is driven to perform to a predetermined threshold.

16. Apparatus according to claim 14 in which said second program is operable to reserve a total amount of memory for use while running and to commit a proportion of said total amount of memory on start up.

17. Apparatus according to claim 16 in which said second program increases said committed memory by predetermined increments concurrently with the running of said first program.

18. Apparatus according to claim 14 in which said second program maintains said committed memory by periodically accessing said committed memory.

19. Apparatus according to claim 14 in which said performance criteria are different for said first and second programs.

20. Apparatus according to claim 14 in which said performance criteria for said first program is a predetermined rate of data processing steps.

21. Apparatus according to claim 14 in which said performance criteria for said second program is a time threshold for periodically accessing said committed memory.

22. Apparatus according to claim 14 in which two instances of said first program are run and said apparatus is further operable to record the memory usage of said second program when said performance of either of said first programs or said second program fails to meet said predetermined performance criteria.

23. Apparatus according to claim 22 in which said apparatus is operable a first time with one instance of said first program and a second time with two instances of said first program and the memory usage of said first program is determined from the difference between the memory usage recorded for said first and second times.

24. Apparatus according to claim 23 in which said memory usage is the real working set for said first program.

25. Apparatus according to claim 14 in which said first program is an application program.

26. Apparatus according to claim 14 in which said first or second programs comprise a group of one or more programs.

27. (canceled)

28. A storage of a program or group of programs arranged to enable a programmable device or group of such devices so that when said program or group of programs are loaded onto said device or such group of devices carry out the method comprising:
a. running a first program;
b. running a second program;
c. increasing the memory allocation of said second program;
d. monitoring the performance of the first and second programs against predetermined performance criteria; and
e. recording the memory usage of said second program when said performance of the first or second program fails to meet said predetermined performance criteria.

29. (canceled)

30. (canceled)
